(19) United States
(12) Patent Application Publication
(10) Pub. No.: US 2010/0095670 A1
(43) Pub. Date: Apr. 22, 2010

(54) METHOD AND DEVICE FOR REGULATING OR CONTROLLING A COMPRESSOR OF AN EXHAUST-GAS TURBOCHARGER

(75) Inventors: Alfred Grzonkowski, Mehlingen (DE); Volker Mueller, Vendersheim (DE)

Correspondence Address: BORGWARNER INC. C/O PATENT CENTRAL LLC, 1401 HOLLYWOOD BOULEVARD, HOLLYWOOD, FL, 33020-5237, US

(73) Assignee: BORGWARNER INC., Auburn Hills, MI (US)

(21) Appl. No.: 12/294,974

(22) PCT Filed: Mar. 28, 2007
(86) PCT No.: PCT/EP2007/002758

§ 371 Date: Nov. 19, 2008

(30) Foreign Application Priority Data
Mar. 29, 2006 (DE) 10 2006 014 815.0

(51) Int. Cl. F02D 23/00

(52) U.S. Cl. 60/602

(57) ABSTRACT

The invention relates to a method for regulating or controlling the compressor (2) of an exhaust gas turbocharger (3) of an internal combustion engine (4), having the following method steps: measuring an ambient air pressure (PU); measuring a static pressure (PV) upstream of the engine inlet; measuring the rotational speed (U) of the exhaust gas turbocharger (3); determining a static pressure (PE) which is present directly at the compressor inlet (11) by calculating a vacuum (Pdyn) in the compressor inlet line (11) and subtracting the calculated vacuum (Pdyn) from the measured ambient air pressure (PU); determining a static pressure (PA) which is present directly at the compressor outlet (12) by calculating the pressure loss (PDV) in the compressor outlet line (18) and adding the calculated pressure loss (PDV-) to the measured static pressure (PV); and regulating or controlling the compressor operation corresponding to at least one of the determined pressure values (PE or PA) and the rotational speed signal (SU).

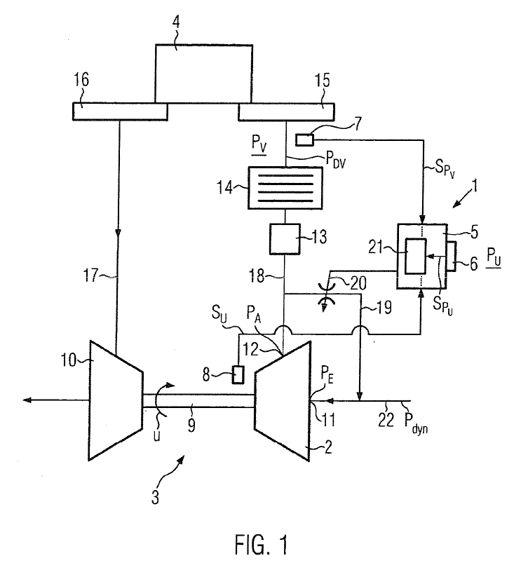

The invention relates to a method and to a device for regulating or controlling the compressor of an exhaust-gas turbocharger of an internal combustion engine, according to claims 1 and 8.

DE 10 2004 059 369 A1 discloses an engine turbocharger control management system in which, for the regulation of the compressor of the turbocharger, a pressure sensor is arranged directly at the inlet of the compressor. A further pressure sensor is provided directly at the outlet of the compressor in the compressor outlet line. Furthermore, a rotational speed sensor is provided which determines the compressor rotational speed, for example by determining the rotational speed of the turbocharger shaft.

Because the pressure of the uncompressed fluid is measured directly at the compressor inlet, a pressure measurement is difficult since, at said point, there is not only clean air but rather for example also added natural gas in the compressor inlet line, as described in the exemplary embodiment of DE 10 2004 059 369 A1, and therefore the pressure measurement carried out directly at the compressor inlet is often distorted owing to pressure fluctuations in the added natural gas. Furthermore, in modern turbochargers, engine blowby is recirculated into the compressor inlet line, which blowby often still contains oil despite an oil filter being positioned upstream, and is admixed to the clean air sucked in by the compressor.

Furthermore, engine exhaust gas from exhaust-gas recirculation is in part recirculated into the compressor inlet line. Despite a particle filter being positioned upstream, it is not possible to prevent particles and exhaust-gas condensate passing into the compressor inlet line, resulting in severe measurement problems.

In any case, a pressure measurement directly at the compressor entails particular expenditure since the sensor must be placed at a possibly difficult-to-access location and must be suitable for the operating conditions prevailing there.

This applies both to the pressure measurement in the compressor inlet line and also in the compressor outlet line. In particular, non-uniform speed distributions as a result of turbulence and/or geometric non-uniformities such as curvatures or discontinuous cross-sectional widenings can adversely affect the pressure measurement.

It is therefore an object of the present invention to create a method and a device for regulating or controlling the compressor of an exhaust-gas turbocharger, which method determines the actual compressor pressure ratio in a sufficiently precise manner, in a simple manner, such that the regulation of the operating behavior of the compressor in the optimum range of the compressor characteristic map can be improved.

Said object is achieved by means of the features of claim 1 and of claim 8.

By using an ambient pressure measurement in connection with the pressure measurement at the engine inlet, it is possible in a simple manner to make a sufficiently accurate approximation to the actual compressor pressure ratio. For this purpose, it is possible to mathematically determine firstly the vacuum in the compressor inlet line and secondly the pressure loss in the compressor outlet line as a result of the losses of the throttle flap and of the charge-air cooler. For a predefined compressor line configuration, the data necessary for calculating the compressor pressure ratio can be determined in advance in an operating-point-specific manner.

By measuring the ambient pressure, preferably an ambient pressure close to the engine, it is possible, instead of measuring a vacuum of a flowing gas mixture, to measure the static pressure of the ambient air, which is considerably simpler and more cost-effective in a technical sense. This results in cost-effective yet sufficiently precise regulation or control of the compressor in the manner described above.

Subclaims 2 to 7 have advantageous refinements of the method according to the invention as their content.

If the ambient pressure is measured directly at the regulating unit, it is possible for the pressure sensor to be attached to or integrated into the regulating unit, which simplifies the design of the regulating system according to the invention.

By measuring the pressure of the compressed fluid directly upstream of or in the inlet line of the internal combustion engine, it is possible for an existing pressure measurement upstream of the engine inlet for the regulation/monitoring of the charge pressure to be used. The throttle flap and the charge-air cooler which are situated upstream of said measuring point have a significant damping influence on the pressure of the fluid, which considerably reduces pressure fluctuations.

The device according to the invention is defined in claims 8 to 11.

Below, an exemplary embodiment of the invention is explained in more detail on the basis of the drawing.

The single figure of the drawing is a schematic, highly simplified illustration of a regulating system 1 according to the invention, for explaining its construction and for explaining the method according to the invention.

The regulating system 1 according to the invention of a compressor 2 of a turbocharger 3 for an internal combustion engine 4 has firstly a regulating unit 5 which may be of conventional design.

In the particularly preferred embodiment illustrated in the figure, a first pressure sensor 6 is arranged directly on or integrated directly into the regulating unit 5, and serves for measuring an ambient pressure P_{U}, preferably an ambient pressure close to the engine, which is a static pressure of the ambient air. The measurement yields a signal S_{PU} which is supplied to a processing unit 21 of the regulating unit 5.

The regulating device 1 according to the invention also has a second pressure sensor 7 which is arranged upstream of an inlet collecting line 15 of the internal combustion engine 4 or which, as an alternative to the illustrated embodiment, can be arranged in the inlet collecting line 15. Said pressure sensor 7 measures a second pressure P_{V} which represents the pressure of the fluid compressed by the compressor 2 before said fluid enters the internal combustion engine 4. The resulting measurement signal S_{PV} is likewise supplied to the regulating unit 5 via a corresponding signal line.

Also provided is a third sensor 8 which is a rotational speed sensor for determining the compressor rotational speed U. Said rotational speed sensor 8 can either be the rotational speed of a shaft 9 which connects the compressor 2 to a turbine 10 of the turbocharger 3, or it is possible for the rotational speed of the compressor wheel or of the turbine wheel (neither of which are illustrated in the drawing) to be determined directly, using signals generated by means of markings or by means of the blades.

The rotational speed signal can additionally be used to protect the exhaust-gas turbocharger from overspeeding.

For completeness of the description, it should be stated that the turbine 10 of the turbocharger is connected by means of an outlet line 17 to the internal combustion engine 4 via the exhaust-gas collecting line 16 of said internal combustion engine 4, in order to be set in rotation by the supplied engine exhaust gas and to thereby drive the compressor wheel of the compressor 2; this is, however, a conventional construction which need not be explained in any more detail for the principles of the present invention.

The figure also shows a bypass line 19 with a bypass valve 20; these represent an option for regulating the compressor 2 which can likewise be implemented in a conventional manner.

Corresponding to the principles of the method according to the invention, the signals S_{U}, S_{PU} and S_{PV} which are supplied to the regulating unit 5 are evaluated of the processing unit 21 of the regulating unit 5, and the regulation of the compressor 2 is thus carried out corresponding to the respective compressor characteristic map in order that the compressor 2 can be operated in an optimum operating range of said characteristic map.

The regulating strategy likewise corresponds to conventional principles, for which purpose reference can be made for example to DE 10 2004 059 369 A1 as explained in the introduction, the disclosure of which is hereby incorporated by explicit reference into the disclosure of the present application.

### LIST OF REFERENCE SYMBOLS

1 Regulating system/regulating device
2 Compressor
3 Turbocharger
4 Internal combustion engine
5 Regulating unit
6 First pressure sensor
7 Second pressure sensor
8 Rotational speed sensor
9 Shaft
10 Turbine
11 Compressor inlet
12 Compressor outlet
13 Throttle flap
14 Charge-air cooler
15 Inlet collecting line
16 Outlet collecting line
17 Outlet line
18 Compressor outlet line
19 Bypass line
20 Bypass valve
21 Processing unit
22 Compressor inlet line
P_{U} Ambient air pressure
P_{V} Static pressure upstream of engine inlet
P_{E} Static pressure directly at compressor inlet 11
P_{A} Static pressure directly at compressor outlet 12
P_{dyn} Vacuum (dynamic pressure) in the compressor inlet line 22
P_{DV} Pressure loss in the compressor outlet line 18 downstream of throttle flap 13 and/or charge-air cooler 14

1. A method for regulating or controlling the compressor (2) of an exhaust-gas turbocharger (3) of an internal combustion engine (4), having the following method steps:
measuring an ambient air pressure (PU) and transmitting a signal (SPU) which represents the ambient air pressure (PU) to a control/regulating unit (5);
measuring a static pressure (PV) upstream of the engine inlet, and transmitting a signal (SPV) which represents the pressure (PV) to the control/regulating unit (5);
measuring the rotational speed (U) of the exhaust-gas turbocharger (3) and transmitting a signal (SPU) which represents the rotational speed value (V) to the control/regulating unit (5);
determining a static pressure (PE) present directly at the compressor inlet (11) by calculating a vacuum (Pdyn) in the compressor inlet line (11) and subtracting the calculated vacuum (Pdyn) from the measured ambient air pressure (PU);
determining a static pressure (PA) present directly at the compressor outlet (12) by calculating the pressure loss (PDV) in the compressor outlet line (18) and adding the calculated pressure loss (PDV) to the measured static pressure (PV); and
regulating or controlling the operation of the compressor by means of the control/regulating unit (5) corresponding to at least one of the determined pressure values (PE or PA) and the rotational speed signal (SU).

2. The method as claimed in claim 1, wherein the ambient air pressure (PU) is measured directly at the regulating unit (5).

3. The method as claimed in claim 1, wherein the pressure of the compressed fluid is measured directly upstream of the inlet collecting line (15) of the internal combustion engine (4).

4. The method as claimed in claim 1, wherein the pressure of the compressed fluid is measured in the inlet collecting line (15) of the internal combustion engine (4).

5. The method as claimed in claim 1, wherein the pressure of the compressed fluid is measured between the throttle flap (13) and the charge-air cooler (14) of the internal combustion engine (4).

6. The method as claimed in claim 1, wherein the pressure of the compressed fluid is measured in the compressor outlet line (18) upstream of the throttle flap (13).

7. The method as claimed in claim 1, wherein an already-existing conventional measuring point for the charge-pressure regulation is used identically as a pressure measuring point of the compressed fluid.

8. A regulating or control device (1)
having a first pressure sensor (6) which is arranged upstream of the compressor inlet (11) to measure an ambient air pressure (PU),
having a second pressure sensor (7) for measuring a static pressure (PV) upstream of the internal combustion engine inlet,
having a rotational speed sensor (8) for measuring the rotational speed of the exhaust-gas turbocharger (3), and
having a control/regulating unit (5), which has a processing unit (21) for determining a static pressure (PE) of the uncompressed fluid directly at the compressor inlet (11) and for determining a static pressure (PA) directly at the compressor outlet (12).

9. The device as claimed in claim 8, wherein the first pressure sensor (6) is arranged directly on the regulating unit (5).

10. The device as claimed in claim 8, wherein the second pressure sensor (7) is arranged between a charge-air cooler (14) and the inlet collecting line (15) of the internal combustion engine (4).

11. The device as claimed in claim 8, wherein the second pressure sensor (7) is arranged in the inlet collecting line (15) of the internal combustion engine (4).
